(19) United States
(12) Patent Application Publication
(10) Pub. No.: US 2019/0157922 A1
(43) Pub. Date: May 23, 2019

(54) ELECTRIC MOTOR

(71) Applicant: Hamilton Sundstrand Corporation, Charlotte, NC (US)

(72) Inventors: Jagadeesh Kumar Tangudu, South Windsor, CT (US); Thomas M. Yun, Glastonbury, CT (US)

(21) Appl. No.: 15/817,738

(22) Filed: Nov. 20, 2017

(51) Int. Cl. H02K 1/20; H02K 9/22; H02K 9/06

(52) U.S. Cl. CPC H02K 1/20; H02K 1/16; H02K 9/06; H02K 9/22

(57) ABSTRACT

A stator assembly of an electric includes a plurality of ring structures centered to an axis. Each one of the plurality of ring structures includes a ring and a plurality of cooling fins projecting radially from and spaced circumferentially about the ring. Each ring structure is disposed axially adjacent to another ring structure of the plurality of ring structures.

### BACKGROUND

The present disclosure relates to an electric motor, and more particularly, to a stator assembly that can cool an electric motor.

Traditional electric motors may include a stator, a rotor, and an aluminum frame with cooling fins located at an exterior of the frame. The cooling fins are adapted to dissipate heat generated in the electric motor due to electromagnetic losses both in the copper windings and laminated steel core (i.e., hysteresis and eddy current). The cooling fins may dissipate the heat via natural and/or forced convection depending upon the design of the motor. Traditional manufacturing techniques include machining of an aluminum structure into straight fins and then integrating (e.g., shrink fit) the structure with the stator at the outer diameter surface. Improvements in manufacturing techniques, versatility in fin design, and optimizing cooling capability are desirable.

### BRIEF DESCRIPTION

A stator assembly of an electric motor according to one, non-limiting, embodiment of the present disclosure includes a plurality of ring structures centered to an axis, each of the plurality of ring structures including a ring and a plurality of cooling fins projecting radially from and spaced circumferentially about the ring, wherein each of the plurality of ring structures is disposed axially adjacent to another one of the plurality of ring structures.

Additionally to the foregoing embodiment, the stator assembly includes electrical windings disposed radially inward from the plurality of ring structures.

In the alternative or additionally thereto, in the foregoing embodiment, each one of the plurality of cooling fins lies within an imaginary plane containing the axis.

In the alternative or additionally thereto, in the foregoing embodiment, the plurality of cooling fins of a first ring structure of the plurality of cooling fins are circumferentially offset from the plurality of cooling fins of an adjacent ring structure of the plurality of ring structures.

In the alternative or additionally thereto, in the foregoing embodiment, the plurality of cooling fins are helical.

In the alternative or additionally thereto, in the foregoing embodiment, the plurality of cooling fins include a first plurality of helical cooling fins angled in a first direction and a second plurality of helical cooling fins angled in an opposite direction.

In the alternative or additionally thereto, in the foregoing embodiment, the first plurality of helical cooling fins is axially adjacent to and circumferentially offset from the second plurality of helical cooling fins.

In the alternative or additionally thereto, in the foregoing embodiment, the first plurality of helical cooling fins is axially adjacent to and circumferentially aligned to the second plurality of helical cooling fins.

An electric motor according to another, non-limiting, embodiment includes a rotor adapted for rotation about an axis; and a stator assembly surrounding the rotor. The stator assembly includes windings; a first ring structure disposed radially outward from and concentric to the rotor, the first ring structure including a first ring and a first plurality of cooling fins spaced circumferentially about and projecting radially from the first ring; and a second ring structure disposed radially outward from and concentric to the rotor, the second ring structure including a second ring and a second plurality of cooling fins spaced circumferentially about and projecting radially from the second ring, wherein the first ring structure is axially adjacent to the second ring structure.

Additionally to the foregoing embodiment, the electric motor includes a fan adapted to rotate with the rotor and configured to induce airflow over the first and second plurality of cooling fins.

In the alternative or additionally thereto, in the foregoing embodiment, the first and second ring structures are part of a stator assembly.

In the alternative or additionally thereto, in the foregoing embodiment, the electric motor includes an external housing, wherein the first and second ring structures are an integral part of the housing.

In the alternative or additionally thereto, in the foregoing embodiment, each one of the first plurality of cooling fins include a first forward edge and an opposite first rearward edge, and each one of the second plurality of cooling fins include a second forward edge and an opposite second rearward edge, and wherein the first forward edge is circumferentially aligned to the first rearward edge and the second forward edge is circumferentially aligned to the second rearward edge.

In the alternative or additionally thereto, in the foregoing embodiment, the first forward edge is circumferentially aligned and axially adjacent to the second rearward edge.

In the alternative or additionally thereto, in the foregoing embodiment, the first forward edge is axially adjacent to and circumferentially offset from the second rearward edge.

In the alternative or additionally thereto, in the foregoing embodiment, the first and second plurality of cooling fins are helical.

In the alternative or additionally thereto, in the foregoing embodiment, each one of the first plurality of cooling fins include a first forward edge and an opposite first rearward edge, and each one of the second plurality of cooling fins include a second forward edge and an opposite second rearward edge, and wherein the first forward edge is circumferentially offset from the first rearward edge and the second forward edge is circumferentially offset from the second rearward edge.

In the alternative or additionally thereto, in the foregoing embodiment, each one of at least one of the first and second plurality of cooling fins is pin-shaped.

In the alternative or additionally thereto, in the foregoing embodiment, each one of at least one of the first and second plurality of cooling fins is shaped like an air-foil.

In the alternative or additionally thereto, in the foregoing embodiment, the stator assembly includes an index feature carried between the first and second rings for circumferentially aligning the first ring to the second ring

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of an electric motor with portions removed to show internal detail, and as one exemplary embodiment;

FIG. 2 is a perspective view of a stator assembly of the electric motor;

FIG. 3 is a perspective view of a ring structure of the stator assembly;

FIG. 4 is a perspective view of a second embodiment of the ring structure;

FIG. 5 is a perspective view of a second embodiment of the stator assembly;

FIG. 6 is a perspective view of a third embodiment of the stator assembly;

FIG. 7 is a perspective view of a fourth embodiment of the stator assembly; and

FIG. 8 is a perspective view of a fifth embodiment of the stator assembly.

### DETAILED DESCRIPTION

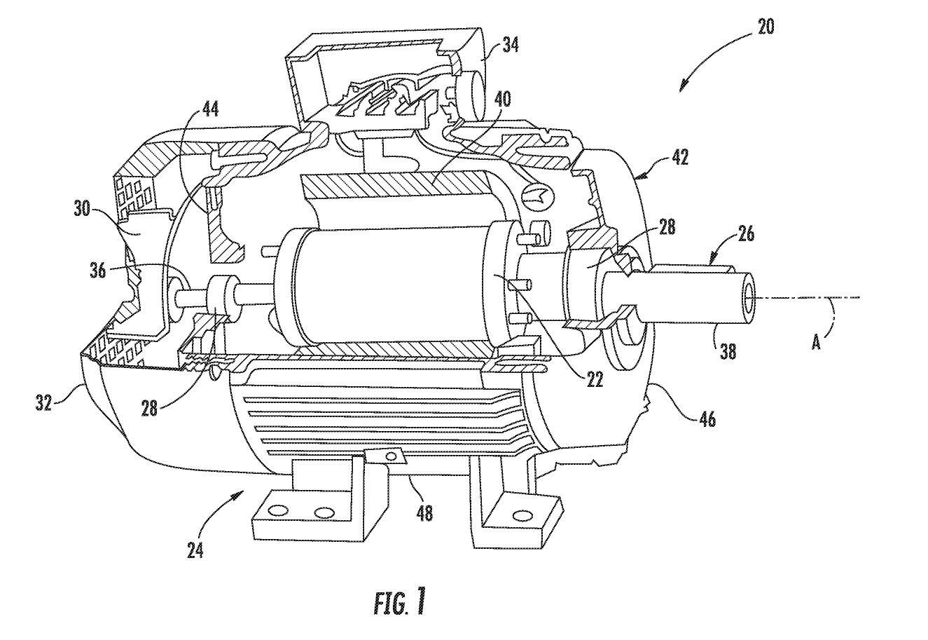

Referring to FIG. 1, an electric motor 20 is illustrated as one, non-limiting, embodiment of the present disclosure. The illustrated electric motor 20 includes a rotor 22 adapted to rotate about a rotation axis A, a stator assembly 24, a rotating shaft 26, bearings 28, a cooling fan 30, a fan cage 32, a terminal box 34, and other components. The shaft 26 is centered to the axis A and may be fixed to the rotor 22, such that the rotor 22 and the shaft 26 rotate together as one piece. The stator assembly 24 is generally located radially outward from the rotor 22 and shaft 26, and is generally stationary during operation of the electric motor 20.

The bearings 28 are adapted to provide structural support and minimize friction between the rotating shaft 26 and the stationary stator assembly 24. In one embodiment, the bearings 28 may be located axially between, and supported by, respective, opposite, end portions 36, 38 of the rotating shaft 26 and the stator assembly 24. The end portions 36, 38 may project from opposite, axial, ends of the rotor 22. End portion 36 may be attached to the cooling fan 30 for rotation of the fan, and end portion 38 may be engaged to any variety of external devices (not shown) adapted to be driven by the electric motor 20.

The stator assembly 24 may include stator windings 40, and an external housing or casing 42. The electrical windings 40 are generally located radially inward from the casing 42, and may be generally supported by and fixed to, the casing 42. The casing 42 may include opposite end segments 44, 46, and a mid-segment 48. The mid-segment 48 may be cylindrical, and/or may be circumferentially continuous, and spans axially between the end segments 44, 46. Each end segment 44, 46 may span radially between the shaft 26 and the mid-segment 48, and may support a respective bearing 28. In one embodiment, the terminal box 34 may be attached to an external surface of the mid-segment 48 for facilitating an electrical connection between the stator windings 40 and an external power source (not shown).

The fan cage 32 facilitates protection of the fan 30, and may provide a safety function by preventing contact of the rotating fan with a person. The cooling fan 30 may generally be axially located between the end segment 44 of the external casing 42 and the fan cage 32. In one embodiment, the fan cage 32 is attached to the end segment 44 of the casing 42.

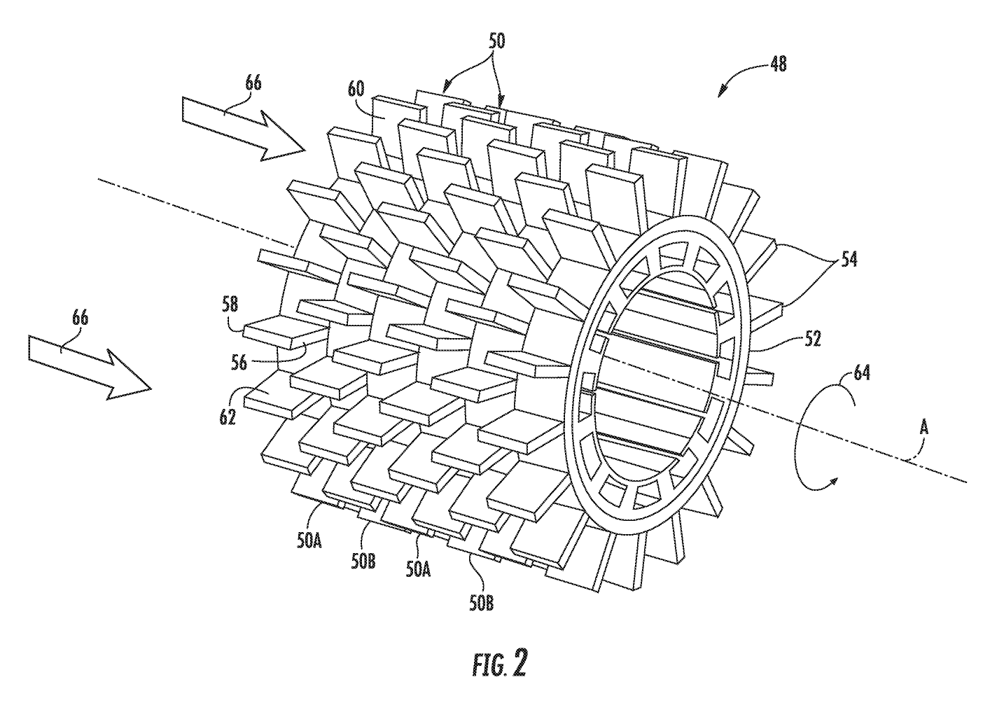

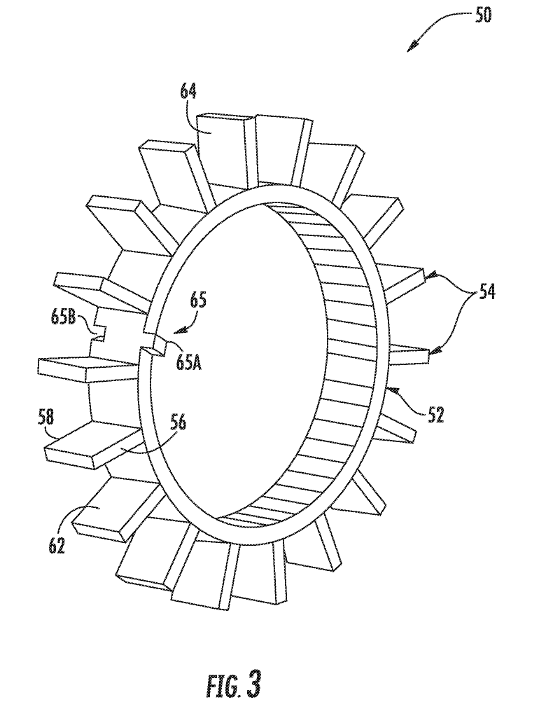

Referring to FIGS. 2 and 3, the mid-segment 48 of the external casing 42 may include a plurality of ring structures 50 axially aligned side-by-side. Each ring structure 50 may include a base ring 52 and a plurality of cooling fins 54. The cooling fins 54 may project radially outward from the ring 52, and may be circumferentially distributed about the ring. Each fin 54 may include an axially forward edge 56 and a rearward edge 58. The edges 56, 58 may substantially project radially outward from the ring 52. Each fin 54 may further include opposite facing surfaces 60, 62 each substantially spanning axially between the edges 56, 58. With respect to the direction of rotation (see arrow 64 in FIG. 2) of the shaft 26, surface 60 may be a leading surface, and surface 62 may be a trailing surface. In one example, each fin 54 may generally lie within a respective, imaginary, plane that contains the axis A. That is, fin 54 may span axially and radially, but may not be angled, or may not be twisted, in a circumferential direction.

Each base ring 52 may include an index feature 65 configured to circumferentially align the base ring 52 to the next, axially adjacent base ring. As illustrated the index feature 65 may include an axially projecting tab 65A adapted to project into a recess 65B of the index feature 65 and in the adjacent base ring. During operation of the electric motor 20, the index feature 65 may also prevent circumferential misalignment of the adjacent base rings 52, and thus misalignment of the respective, axially adjacent, fins 54.

In one embodiment, the fins 54 of a first ring structure 50 may be circumferentially offset from the fins 54 of the next adjacent ring structure. More specifically, the plurality of ring structures 50 may include a multitude of axially alternating ring structures 50A, 50B. Ring structure 50A may be axially adjacent to and disposed between two ring structures 50B, and so on. When the stator assembly 24 is fully assembled, the fins 54 of ring structure 50A may be circumferentially aligned with one-another, and the fins 54 of the ring structure 50B may be circumferentially aligned with one-another. However, the fins 54 of ring structure 50A may be circumferentially centered between adjacent fins 54 of the axially adjacent ring structure 50B. This pattern may generally repeat itself throughout the plurality of ring structures 50.

The ring structures 50A, 50B may generally be the same, but may be orientated differently during assembly of the stator assembly 24. The number of ring structures 50 used in any one application of a motor 20 may be dependent upon the motor itself and/or application and environment of use. It is contemplated and understood that one ring structure type may be applied to a variety of electric motors thereby optimizing motor design versatility and reducing manufacturing and part distribution costs.

During operation of the electric motor 20, the fan 30 produces a flow of cooling air (see arrow 66 in FIG. 2) through the ring structures 50 of the stator assembly 24. In the example of the circumferentially offset ring structures 50, the flow of air may first impinge upon the rearward edges 58 of the offset fins 54 of the first ring structure 50A before flowing past the associated fin surfaces 60, 62, then impinging the rearward edges 58 of the fins 54 of the next ring structure 50B, and so on. The impingement of cooling air against the exposed edges 58 causes an air flow turbulence that increases heat transfer, thereby improving the cooling capability of the fins.

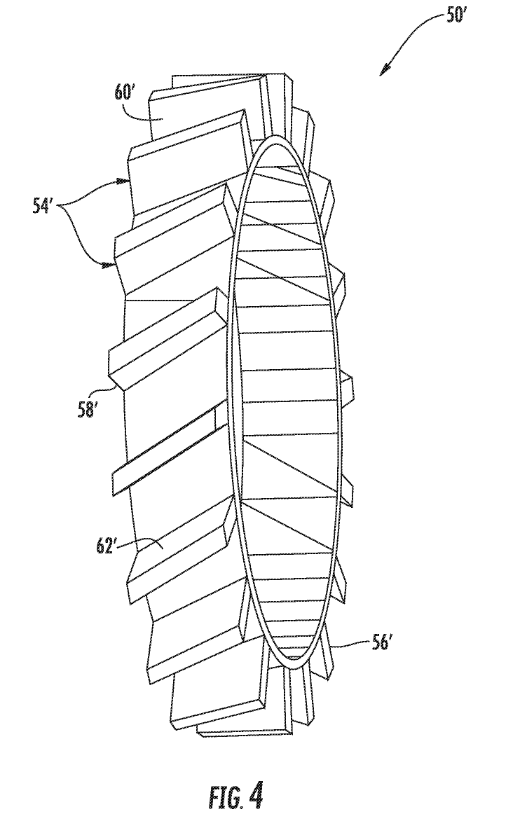

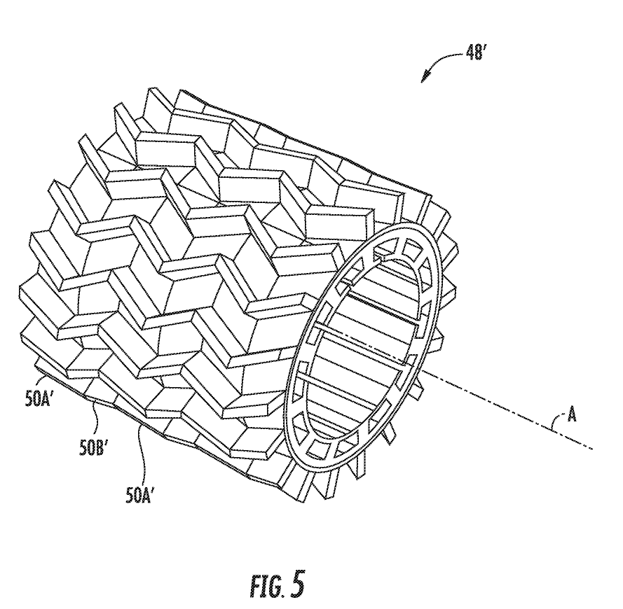

Referring to FIGS. 4 and 5, a second embodiment of the ring structure is illustrated wherein like elements to the first embodiment have like identifying numerals except with the addition of a prime symbol suffix. The ring structure 50′ may include a plurality of fins 54′ each having an axially forward edge 56′ and a rearward edge 58′. The edges 56′, 58′ may substantially project radially outward from the ring 52′. Each fin 54′ may further include opposite facing surfaces 60′, 62′ each substantially spanning, both axially and circumferentially (i.e., fin pitch or slant), between the edges 56′, 58′. In one embodiment, the fins 54, of a first ring structure 50A′ may be pitched at an opposite angle than the fins 54′ of an axially adjacent second ring structure 50B′ of the plurality of ring structures 50′.

Referring to FIG. 5, when a mid-segment 48′ of a stator assembly is fully assembled, the forward edges 56′ of the fins 54′ of the ring structure 50A′ may be circumferentially aligned to, and may be directly axially opposed to, the rearward edges 58′ of the axially adjacent ring structure 50B′. Similarly, the forward edges 56′ of the fins 54′ of the ring structure 50B′ may be circumferentially aligned to, and may be directly axially opposed to, the rearward edges 58′ of the next ring structure 50A′. When fully assembled, the mid-segment 48′ may resemble a pattern that is herringbone-like. The individual ring structures 50′ may be helical ring structures (i.e., helical-like, or chevron fins). The herringbone pattern of the mid-segment 48′ causes cooling air flow turbulence that promotes heat transfer.

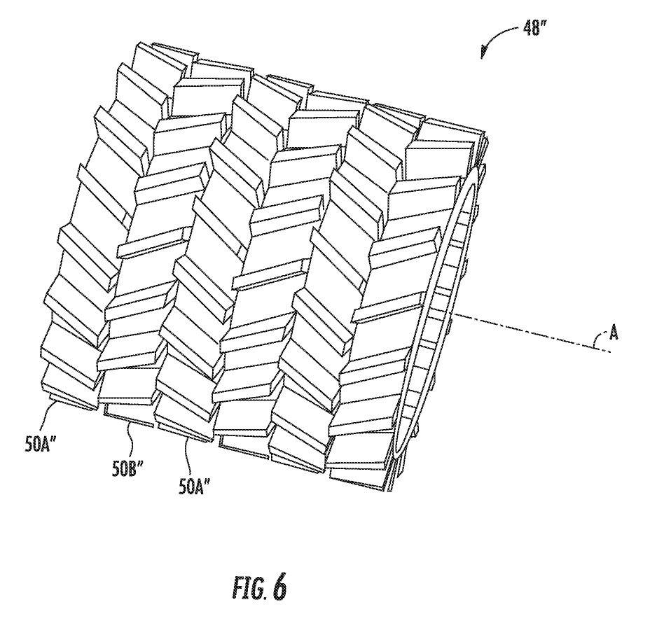

Referring to FIG. 6, a third embodiment of a mid-segment of a stator assembly is illustrated wherein like elements to the first and/or second embodiment have like identifying numerals except with the addition of a double prime symbol suffix. A mid-segment 48″ may generally include the herringbone pattern of the second embodiment, but with the circumferential off-set of the first embodiment. The Herringbone pattern combined with the circumferential off-set between fins may promote further cooling air turbulence to further enhance heat transfer capability. However, the enhancement of heat transfer capability (i.e., breaking the thermal boundary layer) may be predicated on the allowable increase in load placed, for example, on the cooling fan.

Referring to FIG. 7, a fourth embodiment of a mid-segment of a stator assembly is illustrated wherein like elements to the first embodiment have like identifying numerals except with the addition of a triple prime symbol suffix. A mid-segment 48′″ may include a plurality of fins 54′″. Each fin 54′″ may be a projecting pin or stanchion (e.g., cylindrical in shape).

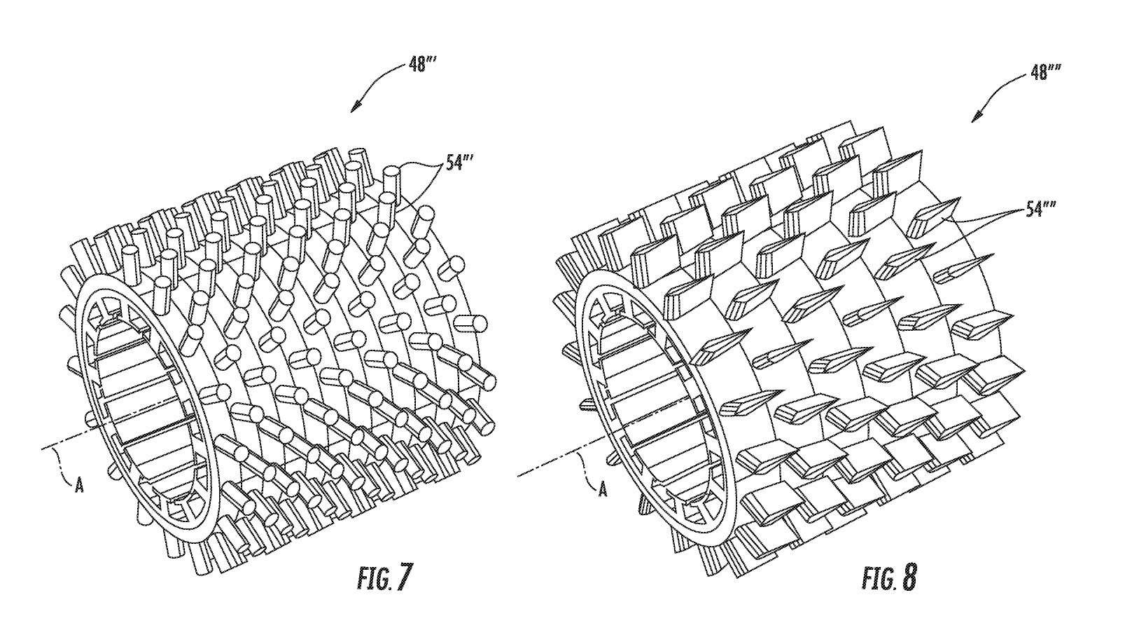

Referring to FIG. 8, a fifth embodiment of a mid-segment of a stator assembly is illustrated wherein like elements to the first embodiment have like identifying numerals except with the addition of a quad prime symbol suffix. A mid-segment 48″″ may include a plurality of fins 54″″. Each fin 54″″ may be in the shape of an air-foil.

Advantages and benefits of the present disclosure include improved heat transfer capability at the thermal boundary layer of each cooling fin. With the resulting higher heat transfer coefficient, cooling performance is optimized and can be varied by assembling patterns. Additional benefits include ease of manufacturing, and the ability to operate the electric motor at higher current density and/or higher power density.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A stator assembly of an electric motor comprising:
a plurality of ring structures centered to an axis, each of the plurality of ring structures including a ring and a plurality of cooling fins projecting radially from and spaced circumferentially about the ring, wherein each of the plurality of ring structures is disposed axially adjacent to another one of the plurality of ring structures.

2. The stator assembly set forth in claim 1, further comprising:
electrical windings disposed radially inward from the plurality of ring structures.

3. The stator assembly set forth in claim 1, wherein each one of the plurality of cooling fins lies within an imaginary plane containing the axis.

4. The stator assembly set forth in claim 3, wherein the plurality of cooling fins of a first ring structure of the plurality of cooling fins are circumferentially offset from the plurality of cooling fins of an adjacent ring structure of the plurality of ring structures.

5. The stator assembly set forth in claim 1, wherein the plurality of cooling fins are helical.

6. The stator assembly set forth in claim 5, wherein the plurality of cooling fins include a first plurality of helical cooling fins angled in a first direction and a second plurality of helical cooling fins angled in an opposite direction.

7. The stator assembly set forth in claim 6, wherein the first plurality of helical cooling fins is axially adjacent to and circumferentially offset from the second plurality of helical cooling fins.

8. The stator assembly set forth in claim 6, wherein the first plurality of helical cooling fins is axially adjacent to and circumferentially aligned to the second plurality of helical cooling fins.

9. An electric motor comprising:
a rotor adapted for rotation about an axis; and
a stator assembly surrounding the rotor, the stator assembly including:
windings;
a first ring structure disposed radially outward from and concentric to the rotor, the first ring structure including a first ring and a first plurality of cooling fins spaced circumferentially about and projecting radially from the first ring; and
a second ring structure disposed radially outward from and concentric to the rotor, the second ring structure including a second ring and a second plurality of cooling fins spaced circumferentially about and projecting radially from the second ring, wherein the first ring structure is axially adjacent to the second ring structure.

10. The electric motor set forth in claim 9, further comprising:
a fan adapted to rotate with the rotor and configured to induce airflow over the first and second plurality of cooling fins.

11. The electric motor set forth in claim 9, wherein the first and second ring structures are part of a stator assembly.

12. The electric motor set forth in claim 9, further comprising:
an external housing, wherein the first and second ring structures are an integral part of the housing.

13. The electric motor set forth in claim 9, wherein each one of the first plurality of cooling fins include a first forward edge and an opposite first rearward edge, and each one of the second plurality of cooling fins include a second forward edge and an opposite second rearward edge, and wherein the first forward edge is circumferentially aligned to the first rearward edge and the second forward edge is circumferentially aligned to the second rearward edge.

14. The electric motor set forth in claim 13, wherein the first forward edge is circumferentially aligned and axially adjacent to the second rearward edge.

15. The electric motor set forth in claim 13, wherein the first forward edge is axially adjacent to and circumferentially offset from the second rearward edge.

16. The electric motor set forth in claim 9, wherein the first and second plurality of cooling fins are helical.

17. The electric motor set forth in claim 16, wherein each one of the first plurality of cooling fins include a first forward edge and an opposite first rearward edge, and each one of the second plurality of cooling fins include a second forward edge and an opposite second rearward edge, and wherein the first forward edge is circumferentially offset from the first rearward edge and the second forward edge is circumferentially offset from the second rearward edge.

18. The electric motor set forth in claim 9, wherein each one of at least one of the first and second plurality of cooling fins is pin-shaped.

19. The electric motor set forth in claim 18, wherein each one of at least one of the first and second plurality of cooling fins is shaped like an air-foil.

20. The electric motor set forth in claim 9, wherein the stator assembly includes an index feature carried between the first and second rings for circumferentially aligning the first ring to the second ring.
